(19) United States
(12) Patent Application Publication
(10) Pub. No.: US 2006/0210692 A1
(43) Pub. Date: Sep. 21, 2006

(54) BABY FOOD COMPOSITION

(76) Inventor: Thomas E. MOWER, Payson, UT (US)

Correspondence Address: STARKWEATHER & ASSOCIATES, 9035 SOUTH 1300 EAST, SUITE 200, SANDY, UT, 84094, US

(21) Appl. No.: 11/307,035

(22) Filed: Jan. 19, 2006

Related U.S. Application Data
(63) Continuation-in-part of application No. 11/083,826, filed on Mar. 18, 2005.

(51) Int. Cl. A23L 1/00

(52) U.S. Cl. 426/618

(57) ABSTRACT

A baby food composition for consumption by, and to provide nutrition to a baby, which includes partially hydrolyzed fucoidan. The fucoidan may be sulfonated. The baby food composition may be in the form of a prepared food, a drink, a hard finger food, a soft finger food, or a cereal.

This application is a Continuation-in-Part of, and claims the benefit of application Ser. No. 11/083,826, filed on 18 Mar. 2005, by Thomas E. Mower, entitled Fucoidan Compositions and Methods for Dietary and Nutritional Supplements, the entirety of which is herein incorporated by reference.

### BACKGROUND OF THE INVENTION

1. Field of the Invention

The present invention relates generally to baby food compositions and, more particularly, to baby food compositions for consumption by and to provide nutrition to a baby.

2. Description of the Related Art

Of the stages of human development, the most important stages have been said to be those at the beginning of life. Because the early stages of life are important for the future and development of the baby, it is important that the baby receive adequate nutrition, and even nutrition that assists in the development of the baby. Physicians and dietitians typically agree that the proper diet for an infant is that provided by nature, and often the most convenient for the mother and baby, that is, human milk.

Human milk typically contains all of the essential nutrients in the necessary proportions needed for proper development of the infant. Human milk may even change in composition as the infant ages. For example, the first human milk that is provided is known as colostrum, which is followed by a mature milk. Human milk contains the ω-3 fatty acid, docosahexaenoic acid (DHA). Human milk typically includes about 3 percent fats, 7.5 percent carbohydrates, 1.2 percent proteins, and 0.25 percent mineral salts. The proteins include casein and lactalbumen, in the amounts of about 0.4 and 0.8 percent of the milk, respectively.

There are many reasons or situations in which an infant is not given human milk. For example, some mothers are not capable of producing milk, or the mother has other reasons for not providing human milk for the infant, such as lack of time, fear of harm to her body and/or breasts, inconvenience, and so forth. Alternatively, the mother may not be available to the infant because of adoption, hospitalization of the mother, and so forth. Further, after a certain period of time, the child is not given human milk, and moves on to eating other foods.

As a result of babies not being fed human milk, another form of aliment must be available to the baby. One popular aliment is cows milk. Though relatively convenient in many parts of the world, cows milk is not the best substitute for human milk, especially for infants. Cows milk contains about 4 percent fat, 4 percent carbohydrates, 4.3 percent protein, and 0.65 percent mineral salts. Further, the cows milk includes about 4 percent casein and 0.3 percent lactalbumen. As such, cows milk contains fewer carbohydrates, much more casein, and less lactalbumen than human milk. Cows milk also lacks other nutrients needed by babies, such as DHA.

As a result, what is needed is an infant formula capable of replacing human milk, and a baby food formula capable of maintaining the nutritional benefits of human milk in the food-based diet of the baby. Some researchers have found ways to modify cows milk, or create a food that is more akin to human milk. This research is represented in the following patents and patent applications.

For example, Nielsen discloses in U.S. Pat. No. 1,607,844 the production of a food for infants, children, and invalids, and its principal object is to produce a food which shall have a nutritive value substantially equal to that of normal human milk. The production includes as its precursors: cows milk, cereals, sweet whey, mineral salts, orange juice, and vitamins.

In another example, Theuer, et al. discloses, in U.S. Patent Application Publication 2003/0207004 baby food compositions comprising about 5% to about 25% egg-yolk solids and an acidulant in an acceptable, shelf-stable, baby-food preparation. The acidulant can be an acid, a cultured food substance containing lactic acid, or a fruit or vegetable component which contributes acidity to the composition of a combination thereof. Also disclosed are methods for preparing and using the compositions. The egg-yolk solids can serve as delivery vehicles for nutrients such as the polyunsaturated fatty acid, DHA, if the eggs are produced by chickens fed diets high in DHA or DHA precursors.

Increasing the concentration of DHA in hen eggs is disclosed, for example, in U.S. Pat. No. 5,415,879 to Oh. According to the Oh patent, chickens are fed a composition including fish oil over a period of time. Modified eggs laid by such chickens contain substantial quantities of omega-3 polyunsaturated fatty acids. The modified eggs are fed to humans with the result that serum cholesterol, serum triglycerides and blood pressure are reduced as compared to humans eating a like number of regular eggs with a subsequent decrease in heart disease. The Theuer patent application publication also discusses the benefits of egg yolks as a part of an infant's diet. Theuer discloses that egg yolks contain substantial levels of nutrients such as high quality protein with all the essential amino acids, many vitamins and minerals, and polyunsaturated fatty acids.

In another example, Theuer further discloses in U.S. Pat. No. 6,051,235, baby-food compositions containing ginger which can be used in reducing gastrophageal reflux in infants. The compositions can contain a ginger puree and one or more fruits or vegetables. Also disclosed are methods of making and using the compositions.

Baby foods may exist in several different forms. One need only peruse an “infants,” or “baby” isle of a supermarket to see the varieties of baby foods. For infants, there are formulas available. The formulas may be purchased for example, in ready-to-use (liquid) form or in powder form that can be dissolved in water before feeding to the infant. These formulas are sold, for example, under the tradename Enfamil® (Mead Johnson & Company, Evansville, Ind.). These formulas are available in several varieties, such as milk-based, soy-based, hypoallergenic (for allergies to cow's milk), low iron, lactose-free, sugar-free, including DHA, and so forth. Formulas are available for stages of the infant and/or child's life. For example, also available under the tradename Enfamil® is a broad range of products for various ages, such as Premature LIPIL® for premature infants, Enfamil® for infants, NEXT STEP® for toddlers of 9-24 months, and Kindercal for children up to the age of 10.

Other than formula-type infant and baby foods are semi-solid and solid foods for infants and children. Infants typically start eating solid or semi-solid foods at about the age of 6 months. Many of the foods available for this stage are available under the tradename Gerber® (Gerber Products Company, Freemont, Mich.). Some of the products available under the Gerber® tradename include juices, cereals, staged foods, finger foods, and organic foods. Some of the juices available include LiquiLites® liquid or powder (for dissolution with water) electrolytes, fruit juices, vegetable juices, and juice and yogurt blends. Some of the cereals available include rice cereals, oatmeal cereals, barley cereals, cereals with fruit, cereals made with the ingredients of formula, and mixtures of grains and fruits. Typically the cereals are sold in a dehydrated form (flakes or powders) for rehydration prior to feeding the baby. Many of the cereals available are fortified with vitamins and/or minerals that may be necessary for the development of the baby.

Staged foods come with different ingredients, viscosity, content of solids/chunks, and so forth. For example, under the tradename of Gerber® is available 1^{st} Foods® which are purees of cooked and fortified vegetables or fruits. 2^{nd} Foods® include prepared cereals, fruits, vegetables, dinners (which include meats), meats, desserts, and tropical fruit desserts. These also may be fortified with vitamins and/or minerals. Further available under the Gerber® tradename are 3^{rd} Foods® including prepared cereals, fruits, vegetables, dinners, desserts, and entrees. The entres include separate sections of different foods.

Also available are “finger foods”. Generally, finger foods include any food that the baby can pick up and feed himself. Some examples of finger foods are available under the tradename Gerber®. These include fruit puffs, veggie puffs, biter biscuits, zwieback toast, veggie wagon wheels, and fruit wagon wheel. These foods are somewhat solid, and shaped such that the baby can pick them up and eat.

One goal common to most baby foods is to include nutrients that the baby needs. Some examples of such nutrients include DHA, the ω-3 fatty acid, arachidonic acid (ARA), vitamins, minerals such as iron, and so forth. Many baby foods are available that are supplemented with vitamins, minerals, DHA, and/or ARA. For example, baby foods sold under the tradename Beech Nut® (Canajoharie, N.Y.), such as First Advantage® contain both DHA and ARA.

Though there are many available baby foods with different nutritive advantages, consumer demand for natural-based products has been growing in recent years. Chemical synthesis is perceived as environmentally unsafe. A chemically synthesized ingredient may contain harsh chemicals. Natural products are perceived as pure and mild and superior to chemically synthesized products. Delivering a dietary benefit to babies from plant sources, however, is not trivial. To derive a real benefit from a natural source, not only should a plant or a part of the plant containing a specific active ingredient be identified, but a minimum concentration and/or a specific extract of that plant should be identified that truly delivers a dietary benefit to babies.

Accordingly, consumers demand an effective baby food composition that helps with growth, mental stimulation, proper development, assistance with the immune system, and does not upset the stomach. Further, consumers demand that the baby food composition be based on natural products to promote the beneficial effects herein described.

Fucoidan is a sulfated polysaccharide found in many sea plants and animals, and is particularly concentrated in the cell walls of brown algae (Phaeophyceae). Fucoidan is a complex carbohydrate polymer composed mostly of sulfated L-fucose residues. These polysaccharides are easily extracted from the cell wall of brown algae with hot water or dilute acid and may account for more than 40% of the dry weight of isolated cell walls. O. Berteau & B. Mulloy, Sulfated Fucans, Fresh Perspectives: Structures, Functions, and Biological Properties of Sulfated Fucans and an Overview of Enzymes Active Toward this Class of Polysaccharide, 13 Glycobiology 29R-40R (2003). Fucoidan structure appears to be linked to algal species, but there is insufficient evidence to establish any systematic correspondence between structure and algal order. High amounts of α(1-3) and α(1-4) glycosidic bonds occur in fucoidans from Ascophyllum nodosum. A disaccharide repeating unit of alternating α(1-3) and α(1-4) bonds represents the most abundant structural feature of fucoidans from both A. nodosum and Fucus vesiculosus which are species of seaweed. Sulfate residues are found mainly in position 4. Further heterogeneity is added by the presence of acetyl groups coupled to oxygen atoms and branches, which are present in all the plant fucoidans. Following is a representation of A. nodosum fucoidan:

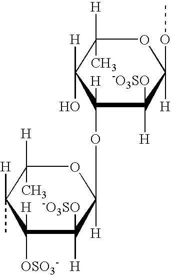

Fucoidan-containing seaweeds have been eaten and used medicinally for at least 3000 years in Tonga and at least 2000 years in China. An enormous amount of research has been reported in the modern scientific literature, where more than 500 studies are referenced in a PubMed search for fucoidan.

The physiological properties of fucoidans in the algae appear to be a role in cell wall organization and possibly in cross-linking of alginate and cellulose and morphogenesis of algal embryos. Fucoidans also have a wide spectrum of activity in biological systems. They have anticoagulant and antithrombotic activity, act on the inflammation and immune systems, have antiproliferative and antiadhesive effects on cells, and have been found to protect cells from viral infection.

Further, fucoidan has numerous beneficial functions that heal and strengthen different systems of the body, including anti-viral, anti-inflammatory, anti-coagulant, and anti-tumor properties. A. I. Usov et al., Polysaccharides of Algae: Polysaccharide Composition of Several Brown Algae from Kamchatka, 27 Russian J. Bio. Chem. 395-399 (2001). Fucoidan has been found to build and stimulate the immune system. Research has also indicated that fucoidan reduces allergies, inhibits blood clotting, fights diabetes by controlling blood sugar, prevents ulcers, relieves stomach disorders, reduces inflammation, protects the kidneys by increasing renal blood flow, and detoxifies the body. Fucoidan also helps to reduce and prevent cardiovascular disease by lowering high cholesterol levels and activating enzymes involved in the beta-oxidation of fatty acids.

A Japanese study found that fucoidans enhanced phagocytosis, the process in which white blood cells engulf, kill, digest, and eliminate debris, viruses, and bacteria. An American study reported that fucoidans increased the number of circulating mature white blood cells. An Argentine study and a Japanese study found that fucoidans inhibited viruses, such as herpes simplex type 1, from attaching to, penetrating, and replicating in host cells. A Swedish study is among the many that showed fucoidans inhibit inflammation cascades and tissue damage that may lead to allergies. Other studies, such as one in Canada, found that fucoidans block the complement activation process that is believed to play an adverse role in chronic degenerative diseases, such as atherosclerosis, heart attack, and Alzheimer's disease. Two American studies found that fucoidans increase and mobilize stem cells.

Researchers have also determined that fucoidan tends to combat cancer by reducing angiogenesis (blood vessel growth), inhibiting metastasis (spreading of cancer cells to other parts of the body), and promoting death of cancer cells. Certain societies that make brown seaweed part of their diet appear to have remarkably low instances of cancer. For example, the prefecture of Okinawa, where the inhabitants enjoy some of the highest life expectancies in Japan, also happens to have one of the highest per capita consumption rates of fucoidans. It is noteworthy that the cancer death rate in Okinawa is the lowest of all the prefectures in Japan.

Brown seaweed, a ready source of fucoidan, is found in abundance in various ocean areas of the world. One of the best locations that provides some of the highest yields of fucoidan is in the clear waters surrounding the Tongan islands, where the seaweed is called limu moui. In Japan, hoku kombu (Laminaria japonica), is said to be particularly rich in fucoidans and is similar to limu moui. The Japanese also consume at least two other types of brown seaweed-wakame and mozuku (Cladosiphon and Nemacystus).

Typically, about four percent by weight of Tongan limu moui is fucoidan. There are at least three types of fucoidan polymer molecules found in brown seaweed. U-fucoidan, having about 20 percent glucuronic acid, is particularly active in carrying out cancer cell destruction. F-fucoidan, a polymer of mostly sulfated fucose, and G-fucoidan, which contains galactose, both tend to induce the production of HGF cells that assist in restoring and repairing damaged cells. All three types of fucoidan also tend to induce the production of agents that strengthen the immune system.

What is needed is a baby food composition that solves one or more of the problems described herein and/or one or more problems that may come to the attention of one skilled in the art upon becoming familiar with this specification. One of such problems is providing a baby food that assists in anti-aging, regeneration of cells and tissues such as muscles and/or bones, promoting growth factors, promoting vitality and youthfulness, strengthening the immune system, reducing allergies, inhibiting blood clotting, controlling blood sugar, preventing ulcers, reliving stomach disorders, reducing inflammation, protecting the kidneys, lowering cholesterol levels, inhibiting smooth muscle cell proliferation, activating enzymes involved in the beta-oxidation of fatty acids and/or detoxifying the body. Another problem is in providing a baby food composition that includes a natural ingredient that more closely mimic's the effects of human milk.

### SUMMARY OF THE INVENTION

The present invention has been developed in response to the present state of the art, and in particular, in response to the problems and needs in the art that have not yet been fully solved by currently available baby food compositions. According to one embodiment of the present invention, there is a baby food composition for consumption by, and to provide nutrition to a baby, comprising partially hydrolyzed fucoidan and a carrier. The fucoidan may be sulfonated. The baby food composition may be dehydrated. The baby food composition may further include mangosteen. The fucoidan may be derived from the group consisting of: Japanese mozuku seaweed, Japanese kombu seaweed, Tongan limu moui seaweed, and combinations thereof. The baby food composition may further include an anti-oxidant beyond any that may be present in fucoidan. The baby food composition may further include an electrolyte.

In one embodiment of the baby food composition, the carrier is a flour. The baby food composition may further include an additional baby food composition in a soft finger food form, comprising partially hydrolyzed fucoidan, fruit, sweetener, and a gelling agent. The flour may be quinoa flour.

In yet another embodiment, the carrier is a cereal. The cereal may be quinoa. The cereal may be toasted.

In still another embodiment, the carrier may be a fruit. The carrier may be a vegetable.

In another embodiment, the carrier may be a juice. The baby food composition may further comprise a milk product. The baby food composition of this embodiment may be dehydrated.

In still yet another embodiment, the present invention includes a baby food composition in the form of a soft finger food, comprising partially hydrolyzed fucoidan, fruit, a gelling agent, sweetener, and quinoa flour, wherein the baby food composition is a gel.

In even another embodiment, the present invention includes a baby food composition in the form of a prepared food, comprising partially hydrolyzed fucoidan, a food base, and quinoa flour.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

In describing and claiming the present invention, the following terminology will be used in accordance with the definitions set out below.

As used herein, “comprising,” “including,” “containing,” “is,” “are,” “characterized by,” and grammatical equivalents thereof are inclusive or open-ended terms that do not exclude additional, unrecited elements or method steps. “Comprising” is to be interpreted as including the more restrictive terms “consisting of” and “consisting essentially of.”

As used herein, “partially hydrolyzed fucoidan” means fucoidan that has been hydrolyzed into smaller polymers and oligomers, but not so thoroughly hydrolyzed as to result in complete hydrolysis to substantially primarily monosaccharides.

As used herein, “baby” means an infant, toddler, or child. Unless the terms “infant,” “toddler,” or “child” are used, then all three are assumed, and contained within the term “baby”.

As used herein, “ORAC” means “oxygen radical absorbance capacity.”

As used herein, “high ORAC value” or similar terms means an ORAC value of at least about 400 per 100 grams of fruit or vegetable. For example, blueberries have an ORAC value of about 2,400 per 100 grams, and the following fruits have ORAC values as shown in parentheses per 100 grams: blackberries (2,036), cranberries (1,750), strawberries (1,540), raspberries (1,220), plums (949), oranges (750), red grapes (739) cherries (670), kiwi fruit (602), and white grapes (446). Other fruits known to have a high ORAC value include black grapes, mangosteen, noni, aronia, wolfberry, and acai, and the like. Further, nutraceutical ingredients known to have high ORAC values include proanthocyanidins, such as from extracts of grape seed and bark of white pine of southern Europe (e.g., pycnogenol, U.S. Pat. No. 4,698,360), and curcuminoids. Oligomeric proanthocyanidins (OPC) are illustrative.

As used herein, “Brix” is a scale for measuring the sugar content of grapes, wine, and the like. Each degree of Brix is equivalent to one gram of sugar per 100 ml of liquid. Thus, an 18 degree Brix sugar solution contains 18% by weight of sugar. Brix also describes the percent of suspended solids in a liquid. Thus, 95 Brix, for example, denotes a liquid that contains 95% by weight of suspended solids. Brix is measured with an optical device called a refractometer. The Brix system of measurement is named for A. F. W. Brix, a 19^{th} century German inventor.

As used herein, “pasteurization” means a process named after scientist Louis Pasteur to destroy harmful bacteria that may be present without substantially affecting flavor and food value. For example, one pasteurization process includes heating every particle of milk to not lower than 62.8° C. (i.e., 145° F.) for not less than 30 minutes and promptly cooling the milk. Currently, the most common method of pasteurization in the United States is High Temperature Short Time (HTST) pasteurization, which uses metal plates and hot water to raise temperatures to 71.7° C. (i.e., 161° F.) for not less than 15 seconds, followed by rapid cooling. Ultra Pasteurization (UP) is a process similar to HTST pasteurization, but using higher temperatures and longer times. UP pasteurization results in a product with longer shelf life but still requiring refrigeration of milk, but not of acidified foods or nutritional supplements (pH<4.6). Another method, Ultra High Temperature (UHT) pasteurization, raises the temperature to over 93.3° C. (i.e., 200° F.) for a few seconds, followed by rapid cooling. A UHT-pasteurized product that is packaged aseptically results in a “shelf stable” product that does not require refrigeration until it is opened.

As used herein, “sterilizing” and similar terms means, with respect to nutritional supplements having a pH less than 4.6 and a water activity greater than 0.85, pasteurizing the nutritional supplement and storing at room temperature. With respect to nutritional supplements having a pH greater than 4.6 and a water activity greater than 0.85, “sterilizing” and similar terms mean applying heat such that the nutritional supplement is rendered free of microorganisms capable of reproducing in the nutritional supplement under normal non-refrigerated conditions of storage and distribution.

As used herein, “aseptic processing and packaging” and similar terms mean the filling of a sterilized cooled product into pre-sterilized containers, followed by aseptic hermetic sealing, with a pre-sterilized closure, in an atmosphere free of microorganisms.

As used herein, “hermetically sealed container” and similar terms mean a container that is designed and intended to be secure against the entry of microorganisms and thereby to maintain the sterility of its contents after processing.

The present invention is drawn toward baby food compositions, which include fucoidan and a carrier such as, for example, baby food cereals, prepared foods, dehydrated foods, drinks, finger foods, and so forth. The baby food compositions may be produced by any method known in the art.

Fucoidan

The present invention advances prior art baby food compositions by providing a baby food composition formulated with fucoidan from seaweed, such as limu moui, kombu, or mozuku. The addition of fucoidan to the baby food composition of the present invention serves to provide significant advantages not found in prior art baby food compositions. The fucoidan-enhanced baby food compositions of the present invention provide many beneficial functions, including simulating human milk, providing for regeneration of cells and tissues; promoting youthfulness; reducing inflammation and the like. In addition, the fucoidan-enhanced baby food compositions of the present invention minimize the unwanted visible signs of both biological and environmental aging. That is, the present dietary supplements slow the unwanted aging process, assist in regenerating damaged cells and tissues, and promote growth factors in the body. Fucoidan is high in antioxidants that help to fight free radical damage to the body that may lead to cancer. These antioxidants help to fight free radical damage caused by the sun and other changing environmental conditions and elements.

Brown seaweed, a source of fucoidan, grows in many oceans, including off the coasts of Japan and Okinawa, Russian coastal waters, Tonga, and other places. An excellent source of fucoidan is the limu moui sea plant growing in the waters of the Tongan islands. This brown seaweed contains many vitamins, minerals, and other beneficial substances and is particularly rich in fucoidan.

Typically, the brown seaweed grows in long angel hair stems with numerous leaves. The fucoidan ingredient is found in natural compositions on the cell walls of the seaweed, providing a slippery sticky texture that protects the cell walls from the sunlight.

In one embodiment, a kombu-type or mozuku-type seaweed is harvested from the coastal waters of the Tongan islands. These seaweeds can be manually harvested, including stems and leaves, by divers and cleaned to remove extraneous materials. The seaweed is then usually frozen in large containers and shipped to a processing plant.

In processing, the heavy outer fibers must first be broken down to provide access to the fucoidan component. If frozen, the seaweed material is first thawed. Then the seaweed material is placed in a mixing vat and shredded, while being hydrolyzed with acids and water. The material may optionally be sulfonated with sulfuric acid to help in breaking down the heavy cell fibers. The mixture may also be buffered with citric acid and thoroughly blended to maintain suspension. The material may also be heated at atmospheric or greater than atmospheric pressure while mixing. The resulting puree is tested and maintained at a pH of about 2 to 4 so as to remain acidic, thus enhancing preservative and stability characteristics.

The puree may be used in preparing baby food compositions. Alternately, the mixture may be frozen in small containers for later processing. In another example, the puree may be dehydrated. The dehydration may be performed by any means known in the art of food processing, such as vacuum drying, spray drying, heating, freeze drying, and so forth. Dehydrated fucoidan may be in any form known in the art, such as, for example in the form of a powder, flakes, pellets, and so forth.

According to one embodiment, the present invention provides a baby food composition formulated with fucoidan compositions from seaweed, such as the limu moui seaweed plant, the Japanese mozuku seaweed, or Japanese kombu seaweed, or mixtures thereof. In another embodiment, the fucoidan may be partially hydrolyzed fucoidan. In yet another embodiment, the fucoidan may be sulfonated. In still another embodiment, the fucoidan compositions are present in selected embodiments in the amount of at least about 0.05 weight percent, or at least about 3 weight percent, or at least about 5 weight percent; and less than about 99 weight percent, or less than about 80 weight percent, or less than about 50 weight percent of the total weight of the baby food composition.

In a further embodiment, the partially hydrolyzed fucoidan may be derived from Tongan limu moui, Japanese hoku kombu (Laminaria japonica), wakame, or mozuku (Cladosiphon and Nemacystus). In yet a further embodiment, the partially hydrolyzed fucoidan may be sulfonated.

Baby Food Cereals

In one embodiment, the baby food composition includes fucoidan and a carrier, wherein the carrier is a cereal. Generally cereals include the edible seeds of grasses. Baby food cereals, however, include an edible composition in which the edible seeds of grasses have been prepared for consumption by a baby. Cereals include, for example, wheat, rice, maize, millets, sorghums, rye, triticale, oats, barley, teff, wild rice, spelt, quinoa, buckwheat, amaranth, cockscomb, and so forth. Cereals are typically a source of starch (this is how the food energy is stored in cereals), protein, amino acids, dietary fiber, essential fatty acids, and other nutrients.

In one embodiment, the cereal includes quinoa. Quinoa is the seed of a leafy plant that is related to spinach. Quinoa grows best in poor soil and in high altitudes. The ancient Incas cultivated and ate quinoa for many years. Quinoa is native of the Andes mountains, and is now cultivated in the higher elevations of the Rocky Mountains. Quinoa provides many nutrients needed not only by babies, but by all humans. Interestingly, quinoa includes the amino acid lysine, which most other grains and cereals lack. This makes the proteins of quinoa more complete, and more akin to the proteins of milk. Quinoa has more iron than many other cereals and grains. Quinoa is also an excellent source of potassium, riboflavin, vitamin B₆, niacin, thiamin, magnesium, zinc, copper, and manganese.

According to one embodiment, the baby food cereal of the present invention may include a cereal, and fucoidan. Further, the baby food cereal may include additives, nutrients, flavorings, coloring, and so forth. Some of the flavorings may include natural flavorings such as fruits, fruit juices, vegetables, vegetable juices, and so forth. In one embodiment, the baby food cereal of the present invention includes only natural ingredients, such as partially hydrolyzed fucoidan, a cereal, fruits, fruit juices, vegetables, vegetable juices, nutrients, and so forth.

Typically cereals must be processed in some manner before being consumed by a baby. As described in U.S. Pat. No. 5,631,032, herein incorporated be a reference, the starches present in cereals may be modified to be better digested by the baby. In one embodiment, the modification process alters the structure of the links between amylase and amylopectin by mixing the cereal with water, heating to temperature of at least 100° C., cooling the mixture, adding enzymes for treatment of hydrolysis for the whole mixture or a part thereof, and drying the mixture. The enzymes may be deactivated.

In an alternative embodiment, the cereal may be toasted. This embodiement may be used together with, or alternatively to the modification process described above. Toasting may be carried out at the temperature of from about 120-150° C. for 15-90 minutes. The toasting and/or modification of starches may be performed before or after the addition of fucoidan. The fucoidan may be in slurry or dehydrated form.

Additional process steps may include inactivating the enzymes, re-heating, addition of chemical reagents, pH adjustments, addition of additional components such as vitamins, minerals, edulcorants, fats, sweeteners, milk, water, fruits, vegetables, or other nutrients, forming into flakes, pellets, powder, dehydrating, spray-drying, and so forth.

The cereal, fucoidan, and additional components may be mixed. Once the components are mixed, the baby food cereal may be consumed, packaged for consumption, or dehydrated. The dehydration may be performed by spray drying, vacuum drying, heating, freeze drying, or any other method of dehydration. The dehydrated baby food cereal may be in the form of pellets, flakes, or powder. The dehydrated baby food cereal may then be consumed, packaged, or reconstituted with a liquid such as milk, water, fruit juice, vegetable juice, and so forth. In one embodiment, the dehydrated baby food cereal is packaged, and later reconstituted by the consumer, whereby it may be consumed. The reconstitution may be by adding liquid.

The additional components may be added to the baby food cereal at any suitable point, and in any suitable form. The additional components may be in a dehydrated form, such as powdered banana, powdered apple, vitamins, minerals and so forth. The dehydrated additional components may be added to the hydrated baby food composition, which may then be dehydrated. Alternativley, the dehydrated additional components may be added to the dehydrated baby food composition, followed by mixing. In another embodiment, the additional components may be in a hydrated form, such as banana, apple, fruit, vegetables, liquid vitamins, liquid minerals, and so forth. The hydrated additional components may be added to the hydrated baby food composition, which may then be dehydrated. Alternativley, the hydrated additional components may be added to the dehydrated baby food composition as the composition is reconstituted.

Dehydrated baby food cereals have several advantages. For example, they may weigh less than the hydrated baby food cereal. Thus, the dehydrated baby food cereal costs less to ship. Further, dehydrated baby food cereal may require less volume for the same nutritional value than hydrated baby food cereal. Dehydrated baby food cereal may have a longer shelf life due to its lack of water, which is needed by many of the microbes that cause the spoilage of food. Further, the consumer may use any number of liquids to reconstitute the dehydrated baby food cereal, and the consumer may reconstitute the dehydrated baby food cereal with a liquid of the consumer's choosing, resulting in an edible composition at a desired temperature.

Hydrated baby food cereals also have advantages. One of which is convenience. A hydrated baby food cereal is ready to eat as it is, and consumers often desire a product that is ready to use when it is purchased. Further, if the baby food cereal is pasteurized and sealed, it may have a substantially long shelf life without substantial risk of spoilage. Thus both hydrated and dehydrated baby food cereal compositions are within the scope of the present invention.

The baby food composition in the form of a cereal includes at least about 0.1 weight percent, or at least about 1 weight percent, or at least about 5 weight percent, and less than about 99 weight percent, or less than about 90 weight percent, or less than about 80 weight percent fucoidan. The balance of the composition may include the carrier and the additional components, if the additional components are added.

Drink

According to one embodiment of the present invention is a baby food composition in the form of a drink. The baby food composition according to this embodiment may include a carrier, and fucoidan, wherein the carrier is a juice. The juice may be a fruit juice or a vegetable juice. The juice may be prepared by any means known in the art of processing foods. In one embodiment, the juice is one from a fruit with a high ORAC value such as the juice of blackberries, cranberries, strawberries, raspberries, plums, oranges, red grapes, cherries, kiwi fruit, white grapes, black grapes, mangosteen, noni, aronia, wolfberry, acai, and the like.

In one embodiment, the baby food drink includes a milk product. The milk product may be, for example, a yogurt, milk, butter, cream, buttermilk, cheese, and so forth. According to one particular embodiment, the milk product is yogurt. The baby food juice with yogurt may be in the form of a smoothie or shake, that is, it is more viscous than typical fruit juice.

The baby food composition in the form of a drink may include any of the additional components listed below under the appropriate heading. Additionally, baby food juice may include added electrolytes. Electrolytes may help to regulate bodily fluid levels, and may be necessary for proper functioning of the heart, muscles, and other organs. The electrolytes may include any edible salt, acid, or base. Some examples of electrolytes may include salts, acids, or bases of sodium, calcium, chlorine, magnesium, potassium, chloride, bicarbonate, and so forth.

The baby food composition in the form of a drink may be dehydrated for later reconstitution. The baby food composition may be dehydrated by any means known in the art, such as spray drying, vacuum drying, heating, freeze drying, and so forth. In one embodiment, the baby food composition is separately dehydrated (that is, some components are separately dehydrated) before the components are mixed. For example, the partially hydrolyzed fucoidan slurry may be dehydrated, and added to a dehydrated fruit or vegetable. Dehydrated fruits and vegetables are commercially available in powder form, for example, from Indo World Trading Corporation (Badarpur, New Delhi, India), and include banana powder, papaya powder, tomato powder, pineapple fruit juice powder, orange juice powder, mango juice powder, grape fruit juice powder, ginger powder, and the like. Additional components may also be added to the dehydrated partially hydrolyzed fucoidan and dehydrated fruit or vegetable. For example, powdered electrolytes, vitamins, minerals, sweeteners, and the like may be added. The powder mixture may then be consumed or rehydrated by the addition of a liquid such as water, milk, fruit juice, and so forth and may then be consumed.

The baby food composition in the form of a drink includes at least about 0.1 weight percent, or at least about 1 weight percent, or at least about 5 weight percent, and less than about 99 weight percent, or less than about 90 weight percent, or less than about 80 weight percent fucoidan. The balance of the composition may include the carrier and the additional components, if the additional components are added.

Prepared Foods

Prepared foods may include those commonly available in readily edible format. Prepared foods typically are available in a slurry or paste form, and sold in single-serving containers. The prepared food of the present invention includes fucoidan and a carrier, wherein the carrier may be a food base.

The food base may be any that is edible by babies. Some examples of food bases may include applesauce, bananas, peaches, pears, prunes, carrots, green beans, peas, squashes, potatoes, sweet potatoes, berries, cherries, grapes, apricots, broccoli, oranges, pineapples, plums, spinach, corn, soy, chicken, noodles, rice, turkey, cheese, macaroni, beef, lamb, ham, veal, and so forth. The food base may be any food or combination of foods prepared in such a manner that it may be consumed by a baby. To be prepared in such a manner, the food may undergo any of the following exemplary processes, or others known in the art of food processing: cooking, roasting, broiling, grilling, boiling, blanching, stewing poaching, sautéing, frying, parboiling, steaming, caramelizing, glazing, braising, pan roasting, toasting, reducing, rendering, scalding, blending, pureeing, pressing, sieving, emulsifying, grinding, grating, crushing, juicing, whipping, kneading, rolling, basting, mashing, cutting, mincing, tenderizing, softening, thinning, thickening, pasteurizing, homogenizing, separating, chopping, cleaving, slicing, and so forth.

The food base may include a flour. The flour may be the flour of a grain, cereal, or nut, such as, for example, red wheat, white wheat, semolina, spelt, rye, barley, oat, rice, maize, millets, sorghums, triticale, teff, wild rice, quinoa, buckwheat, amaranth, cockscomb, and so forth. In one embodiment, the flour includes flour of quinoa.

The food base may include a food with a high e value such as, for example, blackberries, cranberries, strawberries, raspberries, plums, oranges, red grapes, cherries, kiwi fruit, white grapes, black grapes, mangosteen, noni, aronia, wolfberry, acai, and the like. The prepared food may also include any of the additional components listed herein.

The prepared food may be dehydrated. The step of dehydrating may be performed by any dehydrating technique known in the art of processing foods. Dehydration may be done, for example, by spray drying, vacuum drying, freeze drying, heating, and so forth. In one particular embodiment, the components of the prepared food may be dehydrated prior to mixing the separate components. For example, dehydrated potatoes and dehydrated fucoidan may be mixed to form a dehydrated prepared baby food composition. For use, this baby food composition may be reconstituted by the addition of a liquid such as water, milk, vegetable juice, fruit juice, gravy, base, stock, and so forth.

The baby food composition in the form of a prepared food includes at least about 0.1 weight percent, or at least about 1 weight percent, or at least about 5 weight percent, and less than about 99 weight percent, or less than about 90 weight percent, or less than about 80 weight percent fucoidan. The balance of the composition may include the carrier and the additional components, if the additional components are added.

Finger Foods

According to yet another embodiment, the baby food composition of the present invention may be in the form of a finger food. The finger food includes fucoidan. The finger food may include a carrier such as a cereal, a grain, soy, a nut flour, and the like.

The finger food of the present invention may be in any form that a baby can handle and place in her mouth. The finger food may be hard or soft, large or bite-sized. One of the purposes of a finger food is to help the baby with teething. Hard finger foods may be better suited to assist the tooth in breaking out of the gums. Another purpose of finger food is to help the baby learn to chew food. A soft or a tough finger food may be best suited to this end. Accordingly, the present invention is drawn toward both hard and soft finger foods.

In one embodiment, the finger food is of a hard form. In this embodiment, the finger food includes fucoidan, and a carrier. The carrier may include flour. The flour may be of any grain capable of making a flour. Some representative grains may include, for example, red wheat, white wheat, semolina, spelt, rye, barley, oat, rice, maize, millets, sorghums, triticale, teff, wild rice, quinoa, buckwheat, amaranth, cockscomb, and so forth. The grain may be ground until it is in the form of a flour. The grain may be whole, bleached, or separated. The finger food may also contain any of the additional components described herein. The finger food may also include a sweetner. The finger food may include a neutriceutical having a high ORAC value such as, for example, blackberries, cranberries, strawberries, raspberries, plums, oranges, red grapes, cherries, kiwi fruit, white grapes, black grapes, mangosteen, noni, aronia, wolfberry, acai, and the like.

In one particular embodiment, the flour includes the flour of quinoa.

The finger food in hard form may be prepared by combining a liquid, the flour, the fucoidan, and the alternative ingredients, together with a leavening agent. The finger food may include a fat such as butter, oil, shortening, lard, and the like. The leavening agent may include a chemical or a biological leavening agent. Some examples of chemical leavening agents include baking powder, baking soda, and so forth. Some examples of biological leavening agents include yeasts, bacteria, and so forth. The relative amounts of each of the components to make a hard finger food could be calculated by one skilled in the art to make a dough. The dough may then be cooked to form a hard finger food using a technique such as baking, frying, boiling, broiling, grilling, and so forth, for a time and at a temperature that may be easily found by one skilled in the art.

A soft finger food may be in the form of, for example, a dehydrated fruit food product. The soft finger food includes fucoidan and a carrier. The soft finger food may include fruits and/or fruit juices as the carrier. The soft finger food may further include a neutriceutical with a high ORAC value such as, for example, blackberries, cranberries, strawberries, raspberries, plums, oranges, red grapes, cherries, kiwi fruit, white grapes, black grapes, mangosteen, noni, aronia, wolfberry, acai, and the like. The soft finger food may include any of the optional components as described herein. The soft finger food may include sweeteners. The soft finger food may include thickeners such as gluten, starch, or the like. The soft finger food may include a gelling agent.

The gelling agent may be formulated to form a gel upon cooling, heating, curing, drying, or so forth. The type and amount of gelling agent in the soft finger food may be calculated such that the resultant soft finger food may be handled by a baby without the gel breaking, but soft enough to be chewed by a baby with or without teeth. This calculation is within the ability of one skilled in the art. The amount of gelling agent may be at least about 0.01 weight percent, or from about 5 weight percent, and less than about 15 weight percent, or less than about 10 weight percent. Some examples of gels that gel upon cooling include carrageenan, gelatin, gellan gum, agar, alginates, and so forth, which may be used singly or in combination. Examples of alginates include alkali metal alginates such as sodium alginate, alkaline earth metal alginates such as calcium alginate, and so forth. Some general gelling agents include carbohydrate gel forming polymers, such as pectin, gel forming starches, alginates, agar, and so forth.

An emulsifier such as glyceryl monostearate may be present in the soft finger food to maintain product softness over time. The emulsifier may be present in an amount of from about 0.01 to about 3 weight percent. Other emulsifiers could also be used such as glycerol esters, diacetyl tartaric acids, esters of monoglycerides, mono and di-glycerides, polyglycerol esters, polysorbate, propylene glycol esters, rice extract esters, sodium stearoyl-2-lactylate, sorbitan esters, sugar esters, acetylated monoglycerides, lecithin, or combinations thereof.

The soft finger food may include a humectant such as glycerin for moisture retention in an amount of from about 0.01 to about 2 weight percent. Other examples of humectants that could be used include sorbitol solution, a mixture of glycerin and sorbitol, fructose, propylene glycol, or combinations thereof.

A glazing agent such as carnauba wax and beeswax may also be present in the soft finger food in an amount of from about 0.01 to about 2 weight percent, or from about 0.01 to about 0.5 weight percent.

The soft finger food may include a bulking agent configured to add bulk. The bulking agent may be a dextrin, maltodextrin, starch, a modified starch, a flour, or other bulking agent known in the art. In one embodiment, the bulking agent is a flour of a grain or cereal such as, for example, red wheat, white wheat, semolina, spelt, rye, barley, oat, rice, maize, millets, sorghums, triticale, teff, wild rice, quinoa, buckwheat, amaranth, cockscomb, and so forth. In one particular embodiment, the flour is a flour of quinoa. The amount of bulking agent to be provided should be sufficient to provide the desired bulk, but less than enough to sufficiently diminish the desired flavor of the finger food. The bulking agent may be present in the amount of at least about 0.01 weight percent, or at least about 3 weight percent; and less than about 25 weight percent, or less than about 10 weight percent.

The soft finger food may be prepared by partially dehydrating the components of the soft finger food. The components may be mixed in a hydrated form, shaped into the desired shape (which may include a shape, a sheet, a stick, or any desired shape), and partially dehydrated using a method that does not substantially disturb the shape. U.S. Patent Application Publication No. 2005/0191405 to Okos, which is herein incorporated by a reference, describes methods for forming, shaping and gelling food products.

In one embodiment, the soft finger food may be dehydrated by vacuum drying, freeze drying, heating, simple evaporation, and like techniques until the desired state of dehydration is reached. In one embodiment, a product akin to fruit leather is made using the above technique. In yet another embodiment, a nibs of the soft finger food are prepared using the above technique. In still another embodiment, sticks of the soft finger food are prepared by making a sheet form of the soft finger food, followed by tightly rolling the sheet into a stick form. The soft finger food may be consumed in this form. In one embodiment, the soft finger food is formed using a gelling agent. In this embodiment, the soft finger food may be prepared without drying finger food using the above techniques, but the soft finger food may simply cure, or set up over time.

In one embodiment, hard finger food includes pieces, such as nubs of the soft finger food prepared according to the above techniques. This finger food may help with teething due to the presence of the hard phase, as well as the chewing due to the presence of the soft phase of the finger food.

The baby food composition in the form of a finger food includes at least about 0.1 weight percent, or at least about 1 weight percent, or at least about 5 weight percent, and less than about 99 weight percent, or less than about 90 weight percent, or less than about 80 weight percent fucoidan. The balance of the composition may include the carrier and the additional components, if the additional components are added.

Additional Components

In addition to the other components of the various embodiments of the present invention, there are several other components that may be included in the baby or infant foods. There may be other natural components added to the baby food composition. These natural components may include, for example, mangosteen, honey, aloe, sage, clove, ginger, rhubarb, sesame, chamomile, propolis, thyme, lavender, flower or blossom oils, olive oil, palm oil, coconut oil, beeswax, and so forth. One particularly beneficial natural ingredient is a derivative of the mangosteen plant. According to one embodiment, the present invention includes from about 0.01 to about 10 weight percent of a derivative of the mangosteen plant.

The Mangosteen plant (Garcinia mangostana L.) is a tropical fruit-bearing plant named after the French explorer Laurent Garcin. Many of the benefits of the mangosteen plant and its derivatives are descrived in U.S. Pat. No. 6,730,333, which is herein incorporated by a reference. Over the years, the mangosteen plant has been used in a number of different ways. The timber is used for cabinets, building materials, fencing and furniture. The pericarp, containing pectin, tannins, resins and a yellow latex, is used in tanning and dyeing leather black. The fruit pulp is mostly used as a dessert, but can also be canned or made into preserves. However, when removing the fruit pulp from the rind, care must be taken to prevent the tannins and resins of the cut pericarp from contacting the fruit pulp. The mangosteen rind, leaves and bark have also been used as ingredients in folk medicine in areas where the plant grows indigenously. The thick mangosteen rind is used for treating catarrh, cystitis, diarrhea, dysentery, eczema, fever, intestinal ailments, itch, and skin ailments. The mangosteen leaves arc used by some natives in teas and other decoctions for diarrhea, dysentery, fever, and thrush. It is also known that concoctions of mangosteen bark can be used for genitourinary afflictions and stomatosis.

Some of the medicinal properties of the Garcinia mangostana L. plant have been the subject of pharmacological and clinical studies. These studies have isolated chemical constituents in the mangosteen leaves, wood, pericarp and seed aril, which were found to contain the following biologically active compounds, among others: 1,6-dihydroxy-3-methoxy-2-(3-methyl-2-butenyl) xanthone, 1,5,8-trihydroxy-3-methoxy-2-(3-methyl-2-butenyl)xanthone, maclurin, 1,3,6,7-tetrahydroxy xanthone, 1,3,6,7-tetrahydroxy xanthone-O-β-D-glucoside, chrysanthemin, cyaniding-3-O-β-D-sophoroside, 8-deoxygartanin, 1,5-dihydroxy-2-isopentenyl-3-methoxy xanthone, 1,7-dihydroxy-2-isopentenyl-3-methoxy xanthone, 5,9-dihydroxy-8-methoxy-2,2-dimethyl-7-(3-methylbut-2-enyl)2(H), 6(H)-pyrano-(3,2,6)-xanthen-6-one, fructose, garcinone A,B,C, D and E, gartanin, glucose, cis-hex-3-enyl acetate, 3-isomangostin, 3-isomangostin hydrate, 1-isomangostin, 1-isomangostin hydrate, kolanone, mangostin, β-mangostin, α-mangostin, mangostin-3,6-di-O-gulcoside, normangostin, sucrose, tannins, BR-xanthone-A, BR-xanthone-B, calabaxanthone demethylcalabaxanthone, 2-(Y,Y-dimethylallyl)-1,7-dihydroxy-3-methoxyxanthone, 2,8-bis-(Y,Y-dimethylallyl)-1,3,7-trihydroxyxanthone, 1,3,5,8-tetrahydroxy-2,4-diprenylxanthone, and mangostanol. Many of these chemical constituents are xanthones, which are biologically active compounds that are receiving increasing interest in pharmacological studies for a variety of health benefits.

The baby food composition may also include nutraceutical components having a high ORAC value. Free radicals are very reactive and highly destructive compounds in the body. Antioxidants that can be used in dietary supplements include β-carotene, vitamin E, vitamin C, N-acetyl cysteine, α-lipoic acid, selenium, and the like. Antioxidants having a high ORAC value are particularly desirable. Illustratively, nutraceutical antioxidants of high ORAC value that can be used in the present invention include concentrates of grape (red, black, or white), blueberry, acai fruit, raspberry, blackberry, strawberry, plum, orange, cherry, kiwi fruit, currant, elderberry, black currant, cranberry, mangosteen, noni, aronia, wolfberry, and mixtures thereof. Other high ORAC nutraceutical ingredients include proanthocyanidins, such as oligomeric proanthocyanidins, curcuminoids, and the like.

The baby food composition may also include minerals such as, for example, iron, chloride, iodine, magnesium, zinc, selenium, copper, calcium, manganese, silicon, molybdenum, vanadium, sulfur, boron, nickel, tin, phosphorous, chromium, potassium, silver, gold, and so forth. Minerals serve a wide variety of essential physiological functions ranging from structural components of body tissues to essential components of many enzymes and other biological important molecules. Minerals are classified as micronutrients or trace elements on the basis of the amount present in the body. The seven micronutrients (calcium, potassium, sodium, magnesium, phosphorus, sulfur, and chloride) are present in the body in quantities of more than five grams. Trace elements, which include boron, copper, iron, manganese, selenium, and zinc are found in the body in quantities of less than five grams.

Calcium is the mineral element believed to be most deficient in the diet in the United States. Calcium intakes in excess of 300 mg per day are difficult to achieve in the absence of milk and dairy products in the diet. This is far below the recommended dietary allowance (RDA) for calcium (1000 mg per day for adults and children ages one to ten, 1200 mg per day for adolescents and pregnant and lactating women, which equates to about four glasses of milk per day). In fact, it has been reported that the mean daily calcium intake for females over age 12 does not exceed 85 percent of the RDA. In addition, during the years of peak bone mass development (18 to 30), more than 66 percent of all U.S. women fail to consume the recommended amounts of calcium on any given day. After age 35, this percentage increases to over 75 percent.

Although the general public is not fully aware of the consequences of inadequate mineral intake over prolonged periods of time, there is considerable scientific evidence that low calcium intake is one of several contributing factors leading to osteoporosis. In addition, the dietary ratio of calcium to phosphorous (Ca:P) relates directly to bone health. A Ca to P ratio of 1:1 to 2:1 is recommended to enhance bone marrowization in humans. Such ratios are difficult to achieve absent an adequate dietary supply of milk and dairy products, or an adequate supply of calcium and other minerals for the lactose-intolerant segment of the population.

Magnesium is the second most plentiful cation of the intracellular fluids. It is essential for the activity of many enzyme systems and plays an important role with regard to neurochemical transmission and muscular excitability. Deficits are accompanied by a variety of structural and functional disturbances. The average 70-kg adult has about 2000 mEq of magnesium in his body. About 50% of this magnesium is found in bone, 45% exists as an intracellular cation, and 5% is in the extracellular fluid. About 30% of the magnesium in the skeleton represents an exchangeable pool present either within the hydration shell or on the crystal surface. Mobilization of the cation from this pool in bone is fairly rapid in children, but not in adults. The larger fraction of magnesium in bone is apparently an integral part of bone crystal.

The average adult in the United States ingests about 20 to 40 mEq of magnesium per day in an ordinary diet, and of this about one third is absorbed from the gastrointestinal tract. The evidence suggests that the bulk of the absorption occurs in the upper small bowel. Absorption is by means of an active process apparently closely related to the transport system for calcium. Ingestion of low amounts of magnesium results in increased absorption of calcium and vice versa.

Magnesium is a cofactor of all enzymes involved in phosphate transfer reactions that utilize adenosine triphosphate (ATP) and other nucleotide triphosphates as substrates. Various phosphatases and pyrophosphatases also represent enzymes from an enormous list that are influenced by this metallic ion.

Magnesium plays a vital role in the reversible association of intracellular particles and in the binding of macromolecules to subcellular organelles. For example, the binding of messenger RNA (mRNA) to ribosomes is magnesium dependent, as is the functional integrity of ribosomal subunits. Certain of the effects of magnesium on the nervous system are similar to those of calcium. An increased concentration of magnesium in the extracellular fluid causes depression of the central nervous system (CNS). Hypomagnesemia causes increased CNS irritability, disorientation, and convulsions. Magnesium also has a direct depressant effect on skeletal muscle. Abnormally low concentrations of magnesium in the extracellular fluid result in increased acetylcholine release and increased muscle excitability that can produce tetany.

Boron is required by the body in trace amounts for proper metabolism of calcium, magnesium, and phosphorus. Boron helps brain function, healthy bones, and can increase alertness. Boron is also useful for people who want to build muscle. Boron is known to help prevent postmenopausal osteoporosis. Further, a relationship has been shown between a lack of boron in the diet and the chances of developing arthritis. R. E. Newnham, 46 Journal of Applied Nutrition (1994).

Chromium is an important trace element wherein the lack of sufficient chromium in the diet leads to impairment of glucose utilization, however, disturbances in protein and lipid metabolism have also been observed. Impaired glucose utilization occurs in many middle-aged and elderly human beings. In experimental studies, significant numbers of such persons have shown improvement in their glucose utilization after treatment with chromium. Chromium is transported by transferrin in the plasma and competes with iron for binding sites. Chromium as a dietary supplement may produce benefits due to its enhancement of glucose utilization and its possible facilitating the binding of insulin to insulin receptors, which increases its effects on carbohydrate and lipid metabolism. Chromium as a supplement may produce benefits in atherosclerosis, diabetes, rheumatism, and weight control.

Copper is another important trace element in the diet. The most common defect observed in copper-deficient animals is anemia. Other abnormalities include growth depression, skeletal defects, demyelination and degeneration of the nervous system, ataxia, defects in pigmentation and structure of hair or wool, reproductive failure and cardiovascular lesions, including dissecting aneurisms. Several copper-containing metalloproteins have been isolated, including tyrosinase, ascorbic acid oxidase, laccase, cytochrome oxidase, uricase, monoamine oxidase, δ-aminolevulinic acid hydrydase, and dopamine-β-hydroxylase. Copper functions in the absorption and utilization of iron, electron transport, connective tissue metabolism, phospholipid formation, purine metabolism, and development of the nervous system. Ferroxidase I (ceruloplasmin), a copper-containing enzyme, effects the oxidation of Fe(II) to Fe(III), a required step for mobilization of stored iron. A copper-containing enzyme is thought to be responsible for the oxidative deamination of the epsilon amino group of lysine to produce desmosine and isodesmosine, the cross-links of elastin. In copper-deficient animals the arterial elastin is weaker and dissecting aneurisms may occur.

Iodine is important for the production of thyroid hormones, which regulate cellular oxidation. The iodine-deficiency disease is goiter. In iodine-deficient young, growth is depressed and sexual development is delayed, the skin and hair are typically rough, and the hair becomes thin. Cretinism, feeble-mindedness, and deaf-mutism occur in a severe deficiency. There is reproductive failure in females and decreased fertility in males that lack sufficient iodine in the diet.

Iron is an essential component of several important metalloproteins. These include hemoglobin, myoglobin, and many oxidation-reduction enzymes. In iron deficiency, there may be reduced concentrations of some of the iron-containing enzymes, such as cytochrome c in liver, kidney, and skeletal muscle, and succinic dehydrogenase in the kidney and heart.

Manganese plays a role in the synthesis of GAGs, collagen, and glycoproteins, which are important constituents of cartilage and bone. Manganese is required for enzyme activity of glycosyltransferases. This family of enzymes is responsible for linking sugars together into GAGs, adding sugars to other glycoproteins, adding sulfate to aminosugars, converting sugars to other modified sugars, and adding sugars to lipids. These functions are manifested as GAG synthesis (hyaluronic acid, chondroitin sulfate, karatan sulfate, heparin sulfate, and dermatin sulfate, among others), collagen synthesis, and function of many other glycoproteins and glycolipids. GAGs and collagen are chief structural elements for all connective tissues. Their synthesis is essential for proper maintenance and repair of connective tissues.

Manganese deficiencies in humans and animals lead to abnormal bone growth, swollen and enlarged joints, and slipped tendons. In humans, manganese deficiencies are associated with bone loss, arthritis, and impaired glucose utilization. Levels of all GAGs are decreased in connective tissues during manganese deficiencies, with chondroitin sulfates being most depleted. Manganese-deficient organisms quickly normalize GAG and collagen synthesis when manganese is provided.

Manganese is also required for activity of manganese superoxide dismutase (MnSOD), which is present only in mitochondria. Manganese deficiency decreases the activity of MnSOD and may lead to mitochondrial dysfunction, manifested as decreased cellular functions. Manganese is required for the conversion of mevalonic acid to squalene. Pyruvate carboxylase is a manganese metalloenzyme, repressible by insulin, important in the citric acid cycle for the oxidation of carbohydrates, lipids, and proteins, as well as in the synthesis of glucose and lipids.

Molybdenum is an essential mineral found in highest concentrations in the liver, kidneys, skin, and bones. This mineral is required by the body to properly metabolize nitrogen. It is also a vital component of the enzyme xanthine oxidase, which is required to convert purines to uric acid, a normal byproduct of metabolism. Molybdenum also supports the body's storage of iron and other cellular functions such as growth. A deficiency of molybdenum is associated with mouth and gum disorders and cancer. A diet high in refined and processed foods can lead to a deficiency of molybdenum, resulting in anemia, loss of appetite and weight, and stunted growth in animals. While these deficiencies have not been observed directly in humans, it is known that a molybdenum deficiency can lead to impotence in older males.

Selenium is an essential trace element that functions as a component of enzymes involved in protection against antioxidants and thyroid hormone metabolism. In several intra- and extra-cellular glutathione peroxidases and iodothyronine 5′-deiodinases, selenium is located at the active centers as the selenoamino acid, selenocysteine (SeCYS). At least two other proteins of unknown function also contain SeCYS. Although SeCYS is an important dietary form, it is not directly incorporated into these specific selenium-proteins; instead, a co-translational process yields tRNA-bound SeCYS. In contrast, selenium as seleno-methionine is incorporated non-specifically into many proteins, as it competes with methionine in general protein synthesis. Therefore, tissues often contain both specific, as well as the nonspecific, selenium-containing proteins when both SeCYS and selenomethionine are consumed, as found in many foods. Selenium is a major antioxidant nutrient and is involved in protecting cell membranes and preventing free radical generation, thereby decreasing the risk of cancer and disease of the heart and blood vessels. Medical surveys show that increased selenium intake decreases the risk of breast, colon, lung and prostate cancer. Selenium also preserves tissue elasticity; slows down the aging and hardening of tissues through oxidation; and helps in the treatment and prevention of dandruff. Recent research has shown antitumorigenic effects of high levels of selenium in the diets of several animal models.

Vanadium is an essential nutrient beneficial for thyroid hormone metabolism. The daily requirement necessary to prevent a deficiency is about 10 to 20 micrograms a day. Vanadium deficiency can lead to slow growth, defective bones, and altered lipid metabolism. Vanadium exerts an insulin-like effect in some respects, and there has been a considerable amount of research on vanadium and diabetes. In insulin dependent diabetics, vanadium has been found to reduce the amount of insulin required to manage the disease, and in non-insulin dependent diabetics, vanadium has been known to control the condition altogether. Research has shown that supplementation with vanadium leads to an increase in glucose transport into cells, which suggests that vanadium supplementation of the diet improves glucose metabolism and may aid in preventing diabetes.

Zinc is known to occur in many important metalloenzymes. These include carbonic anhydrase, carboxypeptidases A and B, alcohol dehydrogenase, glutamic dehydrogenase, D-glyceraldehyde-3-phosphate dehydrogenase, lactic dehydrogenase, malic dehydrogenase, alkaline phosphatase, and aldolase. Impaired synthesis of nucleic acids and proteins has been observed in zinc deficiency. There is also evidence that zinc may be involved in the secretion of insulin and in the function of the hormone.

According to the present invention, minerals can be provided as inorganic compounds, such as chlorides, sulfates, and the like. In addition, some minerals can be provided in more bioavailable forms, such as amino acid chelates, which are well known in the art. U.S. Pat. No. 5,292,538. Examples of minerals that can be provided as amino acid chelates include calcium, magnesium, manganese, zinc, iron, boron, copper, molybdenum, and chromium. Still further, minerals can be provided as deep sea minerals.

The baby food composition may also include vitamins such as, for example, vitamin A (retinol), vitamin B₁ (thiamine), vitamin B₂ (riboflavin, also known as vitamin G), vitamin B₃ (niacin, also known as vitamin P), vitamin B₅ (pantothenic acid), vitamin B₆ (pyridoxine), vitamin B₇ (biotin, also known as vitamin H), vitamin B₉ (folic acid, also known as vitamin M), vitamin B₁₂ (cyanocobalamin), vitamin C (ascorbic acid), vitamin D₁ (lamisterol), vitamin D₂ (ergocalciferol), vitamin D₃ (calciferol), vitamin D₄ (dihydrotachysterol), vitamin D₅ (7-dehydrositosterol), vitamin E (tocopherol), vitamin K (naphthoquinone), and so forth.

The baby food composition may also include other nutrients such as, for example, dietary fiber; ω-3 fatty acids; proteins; amino acids; fats; cholesterols; sugars; polysaccharides; choline; lycopene; lutein; zeaxanthin; beta-carotene; sweeteners such as momordica fruit, corn syrup, sucrose, dextrose, fructose, crystalline fructose, lactose, malt syrup, malt syrup solids, rice syrup solids, rice syrup, sorghum syrup, invert sugar, refiners syrup, corn syrup, corn syrup solids, maltose, high fructose corn syrup, honey, molasses, sugar alcohols, maltodextrin, and so forth; plant extracts such as green tea extract, grape seed extract, and so forth.

The baby food composition may also include flavonoids. The flavonoids may include those from the groups of flavonols, flavones, flavonones, flavon-3-ols, isoflavones, and anthocyanidins. Some non-limiting examples of edible flavonoids may include, for example, quercetin, rutin, hesperidin, naringin, tangeritin, proanthocyanidins, epicatechin, myricetin, quercetin, kaempferol, luteolin, apigenin, and the like.

The baby food composition may also include anti-oxidants or oxidant scavengers in addition to those that may be present in the fucoidan. Free radicals are products of oxidative deterioration of such substances as polyunsaturated fat. Antioxidants convert free radicals into a less reactive and nonharmful chemical form. Some examples of anti-oxidants include bioflavonoids, amino acids, silymarin, curcumin, all-trans beta-carotene, cis beta-carotenes, all-trans alpha-carotene, cis alpha-carotenes, all-trans lycopene, cis lycopenes, all-trans gamma-carotene, cis gamma-carotenes, zeta-carotene, phytofluene, phytoene, vitamin C and vitamin E and the like.

The baby food composition may also include other nutraceutical component having a high ORAC value. Such nutraceutical components may include, for example, concentrates of black grapes, red grapes, white grapes, blueberry, acai fruit, raspberry, blackberry, strawberry, plum, orange, cherry, kiwi fruit, currant, elderberry, black currant, cranberry, mangosteen, noni, aronia, wolfberry, proanthocyanidins (such as from grape seed extract), curcuminoids, or mixtures thereof.

Packaging

Liquid or hydrated baby food compositions such as hydrated baby food cereals, juice, hydrated prepared foods, and the like. These baby food compositions may be packaged in jars, bottles, cans, or the like. These baby food compositions and/or the packaging may be sterilized so as to increase the probable shelf life of the baby food composition, and/or decrease the probability that the food will spoil before it is consumed. The process of sterilization follows the mixing of the several components of the baby food composition. Once all components are mixed in hydrated or rehydrated form, the mixture is sterilized by pasteurization or other heating techniques. Although pasteurization (at least 87.8° C. or 190° F.) effectively eliminates pathogenic microorganisms, sterilization at higher temperatures may be needed to eliminate all microorganisms.

In achieving the necessary sterilization, two different sterilization processes are typically used. Using the HTST (high temperature short time) process, the mixture may be raised to about 85° C. (185° F.) for about 20-30 seconds. Alternately, the ultra-high temperature (UHT) process involves raising the temperature of the mixture to about 140.6° C. (285° F.) for about 4-6 seconds. In either process, immediately after the heating step, the temperature is rapidly lowered to at least ambient temperatures of about 21.1-26.7° C. (70-80° F.). Alternately, the mixture may be chilled down to about 4.4° C. (40° F.).

Heating of the mixture may be accomplished by direct or indirect heating. For example, the mixture may be heated by direct contact with steam or indirectly by a selected type of heat exchanger.

The sterilized blend may then be poured into containers, using a hot-fill or cold-fill method. In the hot-fill process, the product is first heated to temperatures for pasteurization, HTST, or UHT. Then it is poured into containers at elevated temperatures to kill any microorganisms inside the container. The use of preservatives, such as sodium benzoate and potassium sorbate may be used. The pH is usually maintained below 4.4, possibly using acids such as lemon juice or vinegar. After filling, the baby food composition and baby food composition may be cooled slowly by a water mist. Filling of containers may be done by aseptic processing and packaging methods, which are well known in the art.

In the cold-fill process, after pasteurization or sterilization temperatures are reached, the product is immediately cooled to about room temperature prior to packaging, using aseptic processing and packaging techniques. Immediate cooling allows less vitamin degradation and variations in flavor that may be found in the hot-fill process. Thus, in cold-fill processing the flavor may be cleaner and fresher. Preservatives may be included to control the growth of yeast, molds, and bacteria.

The cold-fill process is compatible with use of high-density polyethylene (HDPE) or polyethylene terephthalate (PET) packaging, so as to not compromise the integrity of the package structure. The containers may be capable of holding only a single serving of the baby food composition.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

Thus, while the present invention has been fully described above with particularity and detail in connection with what is presently deemed to be the most practical embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A baby food composition for consumption by, and to provide nutrition to a baby, comprising partially hydrolyzed fucoidan and a carrier.

2. The baby food composition of claim 1, wherein the fucoidan is sulfonated.

3. The baby food composition of claim 1, wherein the carrier is a flour.

4. The baby food composition of claim 3, further including an additional baby food composition in a soft finger food form, comprising partially hydrolyzed fucoidan, fruit, sweetener, and a gelling agent.

5. The baby food composition of claim 3, wherein the flour comprises quinoa flour.

6. The baby food composition of claim 1, wherein the carrier is a cereal.

7. The baby food composition of claim 6, wherein the cereal comprises quinoa.

8. The baby food composition of claim 6, wherein the cereal is toasted.

9. The baby food composition of claim 1, wherein the carrier is a fruit.

10. The baby food composition of claim 1, wherein the carrier is a vegetable.

11. The baby food composition of claim 1, wherein the carrier is a juice.

12. The baby food composition of claim 11, further comprising a milk product.

13. The baby food composition of claim 11, wherein the baby food composition is dehydrated.

14. The baby food composition of claim 11, further comprising mangosteen.

15. The baby food composition of claim 1, wherein the baby food composition is dehydrated.

16. The baby food composition of claim 1, wherein the fucoidan is derived from one of the group consisting of: Japanese mozuku seaweed, Japanese kombu seaweed, Tongan limu moui seaweed, and combinations thereof.

17. The baby food composition of claim 1, further comprising an anti-oxidant in addition to any andi-oxidant that may be present in the fucoidan.

18. The baby food composition of claim 1, further comprising an electrolyte.

19. A baby food composition in the form of a soft finger food, comprising partially hydrolyzed fucoidan, fruit, a gelling agent, sweetener, and a quinoa flour, wherein the baby food composition is a gel.

20. A baby food composition in the form of a prepared food, comprising partially hydrolyzed fucoidan, a food base, and quinoa flour.
